(19) United States
(12) Patent Application Publication
(10) Pub. No.: US 2005/0074617 A1
(43) Pub. Date: Apr. 7, 2005

(54) Clearcoat composition having both windshield sealant and recoat adhesion

(76) Inventors: Jun Lin, Troy, MI (US); John A. Crowther JR., West Bloomfield, MI (US); Donald Albert Paquet JR., Troy, MI (US); David M. Zukowski, Sterling Heights, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/677,513

(22) Filed: Oct. 2, 2003

(51) Int. Cl. B32B 9/04

(52) U.S. Cl. 428/447; 106/287.12

(57) ABSTRACT

A film-forming coating composition, typically a topcoat, having improved adhesion. The composition includes a film-forming binder comprising a carbamate material, a curing agent, typically a melamine curing agent, and a hydroxy functional silane component. When used as a clearcoat over a standard pigmented basecoat, the resulting coating provides excellent adhesion to both windshield sealants and additional repair coatings.

### BACKGROUND OF THE INVENTION

This invention is directed to a coating composition useful for providing a finish on a variety of substrates, typically automobiles and trucks. In particular, this invention is directed to a curable coating composition comprising a carbamate material, a crosslinking agent reactive therewith, and a hydroxy functional silane component, which when used as a clearcoat in a basecoat/clearcoat finish, cures to provide a coating with excellent adhesion to both windshield sealants and additional repair coatings applied thereover.

In order to protect and preserve the aesthetic qualities of the finish on a vehicle, it is generally known to provide a clear (unpigmented or slightly pigmented) topcoat over a colored (pigmented) basecoat, so that the basecoat remains unaffected even on prolonged exposure to the environment or weathering. This is referred to as a basecoat/clearcoat finish. It is also generally known that the combination of carbamate functional polymers and aminoplast resins, such as melamine, provide coatings with improved chemical or etch resistance, due to the formation of desirable tertiary urethane linkages in coating upon cure. Exemplary of prior patents disclosing such coatings are U.S. Pat. No. 6,451,930. This patent also discloses that that the addition of certain monofunctional silane polymers in additive, i.e., non-film-forming, quantities provides coatings with good adhesion to windshield sealants, due to the presence of active silane groups in the coating. However, such coatings still suffer from poor adhesion to repair coatings, such as when an additional coating is applied on top of the already cured coating to repair damaged areas and defects.

Commercialization of carbamate-melamine finishes has therefore been hindered by several significant or even critical technical hurdles. For example, a commercially practical finish, among other requirements, must have adequate adhesion to repair coatings, also known as recoat adhesion, since defects in the finish may occasionally occur during the original manufacturing process, necessitating on-site repair. A commercially practical finish must also have adequate adhesion to windshield sealants or adhesives, which are typically moisture-cure adhesives containing isocyanate groups, such as those described in U.S. Pat. No. 5,852,137. Typically when a windshield is affixed to the body of a vehicle which has already been painted, a sealant material is used to attach the windshield to the body. However, many of the commonly available windshield adhesives do not adhere well to topcoats that contain carbamate groups. One solution to the problem of failure of windshield sealants to adhere to carbamate containing topcoats is to prime the topcoat with a urethane primer wherever the adhesive is to be applied. Although effective, this method adds an additional step to the process of adhering a windshield to the vehicle body.

Continuing effort has thus been directed to the development of a carbamate functional etch resistant topcoat composition that allows, after application and cure, an excellent balance of windshield sealant adhesion and recoat adhesion, while also meeting today's performance requirements, such as high gloss, DOI (distinctness of image) and low level of orange peel, etch resistance, scratch and mar resistance, and low VOC (volatile organic content) emission requirements. Continuing effort has also been directed to the development of cheaper coatings that contain lesser amounts of film-forming silane resins without sacrificing windshield sealant and recoat adhesion.

The novel coating composition of this invention has the aforementioned desirable characteristics.

### SUMMARY OF THE INVENTION

The present invention provides a curable carbamate group-containing etch resistant coating composition, particularly a topcoat composition, to which, after application and cure, both windshield sealants and additional repair coatings will strongly bond and good appearance can be achieved. The coating composition contains about 45-90% by weight of a film-forming binder and correspondingly about 10-55% by weight of an organic liquid carrier; wherein the binder contains:
(A) a curable film-forming oligomer or polymer having a plurality of secondary carbamate groups;
(B) an alkylated melamine formaldehyde or other aminoplast crosslinking agent; and
(C) a curable film-forming hydroxy functional silane oligomer or polymer having a hydroxyl number of between about 4 and 40 and comprising polymerized ethylenically unsaturated monomers of which about 10 to 97% by weight contain hydrolyzable silyl functionality,
wherein the content of component (C) in the binder ranges from about 2 to about 55% by weight, based on the weight of the binder.

Coatings prepared according to the present invention can be cured and coated with windshield sealants and/or with additional coating(s) such as repair coatings, and have good adhesion to the sealant materials and repair coatings applied thereover.

The invention also provides a method of obtaining recoat adhesion over a carbamate functional topcoat, comprising applying to a substrate at least a basecoat layer and a carbamate functional clearcoat layer and substantially or completely curing the basecoat and the clearcoat thereon, followed by application of at least one additional coating layer, wherein at least the carbamate functional clearcoat layer comprises components (A)-(C). The invention also includes a method for improved adhesion of a cured coating composition to a windshield sealant material.

The invention is based on the discovery that use of certain silane functional compounds that participate in the film-forming curing reaction of the forgoing composition improves the adhesion of the cured film to both windshield bonding adhesives and repair coatings.

### DETAILED DESCRIPTION OF THE INVENTION

As used herein, except where otherwise noted, the term “plurality” shall mean an average of two or more. Also, by the term “substantially cured” or “partially cured” is meant that, although at least some curing has occurred, further curing may occur over time. The term “hydrolyzable silyl functionality” or “hydrolyzable silane functionality” or “active silane functionality” shall mean a material containing a hydrolyzable silyl group of the formula, —Si(Rₙ)X₃₋ₙ, wherein this group is attached to a silyl-containing material by a silicon-carbon bond, and wherein: n is 0, 1 or 2; R is oxysilyl or unsubstituted hydrocarbyl or hydrocarbyl substituted with at least one substituent containing a member selected from the group O, N, S, P, Si; and X is a hydrolyzable moiety selected from the group C₁ to C₄ alkoxy, C₆ to C₂₀ aryloxy, C₁ to C₆ acyloxy, hydrogen, halogen, amine, amide, imidazole, oxazolidinone, urea, carbamate, and hydroxylamine. By the term “monofunctional silane” it is meant a silane compound that contains only hydrolyzable silane functionality and has no other functional groups attached thereto that can participate in the curing reaction. Also the term “secondary carbamate group” as used herein has been described heretofore in the patent and non-patent literature as a urethane group.

This invention relates to carbamate functional etch resistant coatings useful for finishing the exterior of automobile and truck bodies and parts thereof. More particularly, this invention provides a carbamate functional etch resistant coating that is primarily used to form a clearcoat over a pigmented basecoat containing solid color pigments or metallic or pearl flake pigments or mixtures thereof. After application and at least partial cure, the composition demonstrates good windshield sealant adhesion and also good recoat adhesion.

It would be beneficial for cost reasons to formulate etch resistant carbamate topcoat compositions with additive amounts of monofunctional silane resins for windshield sealant adhesion, as shown in previously mentioned U.S. Pat. No. 6,451,930. However, applicants have found that conventional repair basecoats showed poor or inadequate adhesion to the cured topcoat. This poor adhesion is believed due to the phenomenon of silicon stratification at the outside surface (the side in contact with air) of the clearcoat. While such stratification is generally desirable, since it contributes to windshield sealant adhesion, nevertheless such stratification appears to also have an adverse effect on what is known in the art as recoat adhesion. Applicants were able to solve this problem of recoat adhesion by including in the clearcoat composition, a film-forming silane component that contains a critical amount of hydroxy groups which promote recoat adhesion, without destroying the coating's windshield sealant adhesion. This hydroxy functional silane component is also sometimes referred to herein as a “dual (i.e., OH/silane) functional” silane. While not wishing to be bound by theory, it is surmised that the hydroxy groups participate to a substantial extent in the film-forming reaction and thereby minimize silicon stratification so that recoat adhesion is not destroyed.

As mentioned above, the curable film-forming composition of this invention is typically used as a clear coating composition, i.e. containing no pigments or a small amount of transparent pigment. The composition preferably has a relatively high solids content of about 45-90% by weight of binder and correspondingly about 10-55% by weight of an organic carrier which can be a solvent for the binder or a mixture of solvents. The coating of the present invention is also preferably a low VOC (volatile organic content) coating composition, which means a coating that includes less than 0.6 kilograms of organic solvent per liter (5 pounds per gallon) of the composition as determined under the procedure provided in ASTM D3960.

The film-forming portion of the present coating composition, comprising the polymeric and other film-forming components, is referred to as the “binder” or “binder solids” and is dissolved, emulsified or otherwise dispersed in an organic solvent or liquid carrier. The binder generally includes all the normally solid polymeric and other film-forming components of the composition. Generally, catalysts, pigments, or chemical additives such as stabilizers are not considered part of the binder solids. Non-binder solids other than pigments usually do not amount to more than about 10% by weight of the composition. In this disclosure, the term binder or binder solids includes the film-forming, carbamate materials, crosslinking agents, the reactive silane component, and all other optional film-forming components.

The binder used in the coating composition of the present invention is a blend of materials which contains about 5-60% by weight, preferably 10-40%, of a curable film-forming carbamate functional material.

The curable carbamate functional material used in the practice of present invention may be an oligomeric or polymeric material that contains at least 2 carbamate groups per molecule. The carbamate groups may be primary or secondary, although this invention is particularly directed to carbamate materials with secondary carbamate groups. Also in this invention, lower molecular weight materials, such as oligomers, are generally preferred.

Such oligomeric carbamate functional compounds will generally have a weight average molecular weight ranging from about 75-2,000, and preferably from about 75-1,500. All molecular weights disclosed herein are determined by GPC (gel permeation chromatography) using a polystyrene standard. These lower molecular weight materials can be prepared in a variety of ways, which are well known in the art.

In a preferred embodiment, these lower molecular weight materials are prepared by reacting a polyisocyanate, preferably an aliphatic polyisocyanate, with a monofunctional alcohol to form an oligomeric compound having multiple secondary carbamate groups, as described in WO 00/55229, the disclosure of which is incorporated herein by reference. This reaction is performed under heat, preferably in the presence of catalyst as is known in the art.

Various polyisocyanate compounds can be used in the preparation of these secondary carbamate compounds. The preferable polyisocyanate compounds are isocyanate compounds having 2 to 3 isocyanate groups per molecule. Typical examples of polyisocyanate compounds are, for instance, 1,6-hexamethylene diisocyanate, isophorone diisocyanate, 2,4-toluene diisocyanate, diphenylmethane-4,4′-diisocyanate, dicyclohexylmethane-4,4′-diisocyanate, tetramethylxylidene diisocyanate, and the like. Trimers of diisocyanates also can be used such as the trimer of hexamethylene diisocyanate (isocyanurate) which is sold under the tradename Desmodur® N-3390, the trimer of isophorone diisocyanate (isocyanurate) which is sold under the tradename Desmodur® Z-4470 and the like.

Polyisocyanate functional adducts can also be used that are formed from any of the forgoing organic polyisocyanate and a polyol. Polyols such as trimethylol alkanes like trimethylol propane or ethane can be used. One useful adduct is the reaction product of tetramethylxylidene diisocyanate and trimethylol propane and is sold under the tradename of Cythane® 3160. When the curable carbamate functional resin of the present invention is used in exterior coatings, the use of an aliphatic or cycloaliphatic isocyanate is preferable to the use of an aromatic isocyanate, from the viewpoint of weatherability and yellowing resistance.

Any monohydric alcohol can be employed to convert the above polyisocyanates to secondary carbamate groups. Some suitable monohydric alcohols include methanol, ethanol, propanol, butanol, isopropanol, isobutanol, hexanol, 2-ethylhexanol, and cyclohexanol.

In another embodiment, the lower molecular weight secondary carbamate materials can be formed by reacting a monofunctional isocyanate, preferably an aliphatic monofunctional isocyanate, with a polyol, as will be appreciated by those skilled in the art.

Typical of such above-mentioned low molecular weight secondary carbamate materials are those having the following structural formulas: 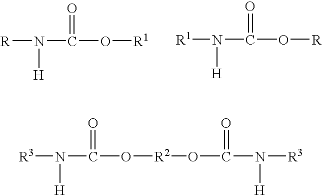
where R is a multifunctional oligomeric or polymeric material; R¹ is a monovalent alkyl or cycloalkyl group, preferably a monovalent C₁ to C₁₂ alkyl group or C₃ to C₆ cycloalkyl group, or a combination of alkyl and cycloalkyl groups; R² is a divalent alkyl or cycloalkyl group, preferably a divalent C₁ to C₁₂ alkyl group or C₃ to C₆ cycloalkyl group, or a combination of divalent alkyl and cycloalkyl groups; and R³ is either R or R¹ as defined above.

Carbamate functional polymers, particularly those with secondary carbamate groups, may also be used in the practice of this invention. Such polymers are well-known in the art. Such polymers can be prepared in a variety of ways and are typically acrylic, polyester, or polyurethane containing materials with pendant and/or terminal carbamate groups. Acrylic polymers are generally preferred in automotive topcoats.

Mixtures of the polymeric and oligomeric carbamate functional compounds may also be utilized in the coating composition of the present invention.

The film-forming binder portion of the composition of this invention also contains from about 15 to 45%, preferably 20 to 40%, by weight, based on the weight of the binder, of a crosslinking component with at least two groups which are reactive with carbamate functional groups. A number of crosslinking materials are known that can react with carbamate groups and form the desired urethane linkages in the cured coating, which linkages, as indicated above, are desirable for their durability, resistance to attack by acid rain and other environmental pollutants, and scratch and mar resistance. These include aminoplast resins such as melamine formaldehyde resins (including monomeric or polymeric melamine resin and partially or fully alkylated melamine resin), urea resins (e.g., methylol ureas such as urea formaldehyde resin, alkoxy ureas such as butylated urea formaldehyde resin), and phenoplast resins such as phenolformaldehyde adducts.

Aminoplast crosslinking agents, most preferably a partially or fully alkylated aminoplast crosslinking agent, are typically included in the film-forming compositions of the present invention. These crosslinking agents are well known in the art and contain a plurality of functional groups, for example, alkylated methylol groups, that are reactive with the pendant or terminal carbamate groups present in the film-forming polymer and are thus capable of forming the desired urethane linkages with the carbamate functional polymers. Most preferably, the crosslinking agent is a monomeric or polymeric melamine-formaldehyde condensate that has been partially or fully alkylated, that is, the melamine-formaldehyde condensate contains methylol groups that have been further etherified with an alcohol, preferably one that contains 1 to 6 carbon atoms. Any monohydric alcohol can be employed for this purpose, including methanol, ethanol, n-butanol, isobutanol, and cyclohexanol. Most preferably, a blend of methanol and n-butanol is used. Such crosslinking agents typically have a weight average molecular weight of about 500-1,500, as determined by GPC using polystyrene as the standard.

Suitable aminoplast resins of the forgoing type are commercially available from Cytec Industries, Inc. under the trademark CYMEL® and from Solutia, Inc. under the trade name RESIMENE®.

Mixtures of the aforementioned crosslinking agents can also be utilized in the coating composition of the present invention.

In addition to the carbamate materials and crosslinking components described above, the film-forming portion of the coating composition also contains a film-forming reactive hydroxyl functional silane compound. This is a key component of the composition of the present invention. The hydroxy functional silane material utilized herein is a compound that contains an average of one or more hydrolyzable silyl groups and has a hydroxyl value of about 4 to 40. This material can be an oligomeric or polymeric material including a polysiloxane based material. In this invention, polymeric materials, especially those prepared from ethylenically unsaturated monomers which are listed hereinafter, are generally preferred.

The hydroxy functional silane component is incorporated in the film-forming portion of the composition in an amount sufficient to achieve recoat adhesion, while maintaining primerless windshield bonding capability. Typically, the hydroxy functional silane component is used in an amount ranging from about 2 to 55% by weight, preferably from about 4 to 45% by weight, based on the weight of the binder.

The hydroxy functional silane polymers that preferably may be used in the practice of this invention can be prepared in a variety of ways and are typically acrylic, polyester or epoxy containing materials. As indicated above, acrylic polymers are generally preferred in automotive topcoats. Such polymers will generally have a weight average molecular weight of 1,000-30,000, and preferably between 2,000 and 10,000 as determined by gel permeation chromatography (GPC) using polystyrene as the standard.

In a preferred embodiment, the hydroxy functional silane polymer is the polymerization product of ethylenically unsaturated monomers such as are listed hereinafter, of which from about 10 to 97% by weight, preferably 30 to 80% by weight, and more preferably 50 to 75% by weight, based on the weight of the polymer, are ethylenically unsaturated monomers which contain hydrolyzable silane functionality. As indicated above, the average number of hydroxyl groups on the polymer can vary; however such materials should have a hydroxyl number greater than 1, preferably ranging from about 4 to 40, and more preferably from about 10 to 30 (mg KOH/g resin solids), in order to achieve the desired recoat adhesion while maintaining primeness windshield bonding capability.

One way to prepare these polymers is to copolymerize the ethylenically unsaturated monomer having silane functionality into a polymer prepared from ethylenically unsaturated monomers. For example, silane functional groups can be incorporated into a polymer prepared from ethylenically unsaturated monomers by copolymerizing, for example, an ethylenically unsaturated silane functional monomer with a hydroxy functional non-silane containing ethylenically unsaturated monomer, such as a hydroxy functional alkyl acrylate or methacrylate, and optionally other polymerizable non-silane containing ethylenically unsaturated monomers.

Useful hydroxy functional ethylenically unsaturated monomers include, for example, hydroxy alkyl (meth)acrylates meaning hydroxy alkyl acrylates and hydroxy alkyl methacrylates having 1-4 carbon atoms in the alkyl groups such as hydroxy methyl acrylate, hydroxy methyl methacrylate, hydroxy ethyl acrylate, hydroxy ethyl methacrylate, hydroxy propyl methacrylate, hydroxy propyl acrylate, hydroxy butyl acrylate, hydroxy butyl methacrylate and the like. The presence of hydroxy functional monomers enables additional crosslinking to occur between the hydroxy groups and silane moieties on the silane polymer and/or between the hydroxy groups with other crosslinking groups (such as melamine groups) that may be present in the top coat composition, to minimize silicon stratification in the final top coat and provide optimal recoat adhesion.

Other suitable non-silane containing monomers include alkyl acrylates, alkyl methacrylates and any mixtures thereof, where the alkyl groups have 1-12 carbon atoms, preferably 2-8 carbon atoms. Suitable alkyl methacrylate monomers are methyl methacrylate, ethyl methacrylate, propyl methacrylate, butyl methacrylate, isobutyl methacrylate, pentyl methacrylate, hexyl methacrylate, octyl methacrylate, nonyl methacrylate, lauryl methacrylate and the like. Similarly, suitable alkyl acrylate monomers include methyl acrylate, ethyl acrylate, propyl acrylate, butyl acrylate, isobutyl acrylate, pentyl acrylate, hexyl acrylate, octyl acrylate, nonyl acrylate, lauryl acrylate and the like. Cycloaliphatic methacrylates and acrylates also can be used, for example, such as trimethylcyclohexyl methacrylate, trimethylcyclohexyl acrylate, isobornyl methacrylate, isobornyl acrylate, t-butyl cyclohexyl acrylate, or t-butyl cyclohexyl methacrylate. Aryl acrylate and aryl methacrylates also can be used, for example, such as benzyl acrylate and benzyl methacrylate. Of course, mixtures of the two or more of the above mentioned monomers are also suitable.

In addition to non-silane containing alkyl acrylates or methacrylates, other polymerizable monomers, up to about 50% by weight of the polymer, can be also used in the hydroxy functional silane polymer for the purpose of achieving the desired properties such as hardness, appearance, and the like. Exemplary of such other monomers are styrene, methyl styrene, acrylamide, acrylonitrile, methacrylonitrile, and the like.

The silane containing monomers that may be utilized in forming the hydroxy silane material include alkoxy silanes having the following structural formula: 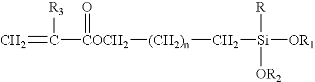
where R is either CH₃, CH₃CH₂, CH₃O, or CH₃CH₂O; R₁ and R₂ are independently CH₃ or CH₃CH₂; and R₃ is either H, CH₃, or CH₃CH₂; and n is 0 or a positive integer from 1 to 10. Preferably, R is CH₃O or CH₃CH₂O and n is 1. Typical examples of such alkoxysilanes are the acrylatoalkoxy silanes, such as gamma-acryloxypropyl trimethoxysilane and the methacrylatoalkoxy silanes, such as gamma-methacryloxypropyl trimethoxysilane (Silquest® A-174 from Crompton), and gamma-methacryloxypropyltris(2-methoxyethoxy) silane.

Other suitable alkoxy silane monomers have the following structural formula: 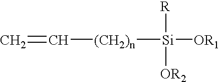
where R, R₁ and R₂ are as described above and n is 0 or a positive integer from 1 to 10. Examples of such alkoxysilanes are the vinylalkoxy silanes, such as vinyltrimethoxy silane, vinyltriethoxy silane and vinyltris(2-methoxyethoxy) silane.

Other suitable silane containing monomers are ethylenically unsaturated acryloxysilanes, including acrylatoxy silane, methacrylatoxy silane and vinylacetoxy silanes, such as vinylmethyldiacetoxy silane, acrylatopropyl triacetoxy silane, and methacrylatopropyltriacetoxy silane. Of course, mixtures of the above-mentioned silane containing monomers are also suitable.

Silane functional macromonomers also can be used in forming the hydroxy functional silane polymer. For example, one such macromonomer is the reaction product of a silane containing compound, having a reactive group such as epoxide or isocyanate, with an ethylenically unsaturated non-silane containing monomer having a reactive group, typically a hydroxyl or an epoxide group, that is co-reactive with the silane monomer. An example of a useful macromonomer is the reaction product of a hydroxy functional ethylenically unsaturated monomer such as a hydroxyalkyl acrylate or methacrylate having 1-4 carbon atoms in the alkyl group and an isocyanatoalkyl alkoxysilane such as isocyanatopropyl triethoxysilane.

Typical of such above-mentioned silane functional macromonomers are those having the following structural formula: 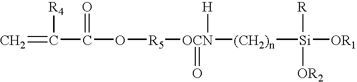
where R, R₁, and R₂ are as described above; R₄ is H or CH₃, R₅ is an alkylene group having 1-8 carbon atoms and n is a positive integer from 1-8.

Consistent with the above mentioned components, an example of a hydroxy functional acrylic silane polymer useful in the practice of this invention is composed of polymerized monomers of styrene, an ethylenically unsaturated alkoxy silane monomer which is either an acrylate, methacrylate or vinyl alkoxy silane monomer or a mixture of these monomers, a nonfunctional acrylate or methacrylate or a mixture of these monomers and a hydroxy alkyl acrylate or methacrylate that has 1-4 carbon atoms in the alkyl group such as hydroxy ethyl acrylate, hydroxy propyl acrylate, hydroxy butyl acrylate, hydroxy ethyl methacrylate, hydroxy propyl methacrylate, hydroxy butyl methacrylate and the like or a mixture of these monomers.

One preferred acrylic polymer contains the following constituents: about 1-30% by weight styrene, about 1-96% by weight gamma-methacryloxypropyl trimethoxysilane, and about 1-30% by weight isobutyl methacrylate, 1-30% by weight butyl acrylate, and less than 10% by weight, more preferably about 1-9% by weight hydroxy propyl acrylate. The total percentage of monomers in the polymer equal 100%. This polymer preferably has a weight average molecular weight ranging from about 1,000 to 20,000.

One particularly preferred acrylosilane polymer contains about 10% by weight styrene, about 65% by weight gamma-methacryloxypropyl trimethoxysilane, about 20% by weight of nonfimctional acrylates or methacrylates such as trimethylcyclohexyl methacrylate, butyl acrylate, and iso-butyl methacrylate and any mixtures thereof, and about 5% by weight of hydroxy propyl acrylate.

The polymers prepared from ethylenically unsaturated monomers can be prepared by standard solution polymerization techniques, which are well-known to those skilled in the art, in which the monomers, solvent, and polymerization initiator are charged over a 1-24 hour period of time, preferably in a 2-8 hour time period, into a conventional polymerization reactor in which the constituents are heated to about 60-175° C., preferably about 110-170° C. The ratio of reactants and reaction conditions are selected to result in a silane polymer with the desired hydroxy functionality.

In an alternate embodiment of the present invention, the hydroxy functional silane material may also contain a plurality of secondary carbamate groups, and accordingly the carbamate and silane components (A) and (C) in the present invention can be one material.

The hydroxy functional silane materials can also be oligomeric in nature. These materials are well known in that art.

Mixtures of polymeric and oligomeric hydroxy functional silane compounds may also be utilized in the present invention.

In addition to the above components in the coating composition, other film-forming and/or crosslinking solution polymers may be included in the present application. Examples include conventionally known acrylics, cellulosics, isocyanates, blocked isocyanates, urethanes, polyesters, epoxies or mixtures thereof. One preferred optional film-forming polymer is a polyol, for example an acrylic polyol solution polymer of polymerized monomers. Such monomers may include any of the aforementioned alkyl acrylates and/or methacrylates and in addition, hydroxy alkyl acrylates and/or methacrylates. Suitable alkyl acrylates and methacrylates have 1-12 carbon atoms in the alkyl groups. The polyol polymer preferably has a hydroxyl number of about 50-200 and a weight average molecular weight of about 1,000-200,000 and preferably about 1,000-20,000.

To provide the hydroxy functionality in the polyol, up to about 90% preferably 20 to 50%, by weight of the polyol comprises hydroxy functional polymerized monomers. Suitable monomers include hydroxy alkyl acrylates and methacrylates, for example, such as the hydroxy alkyl acrylates and methacrylates listed hereinabove and mixtures thereof.

Other polymerizable non-hydroxy-containing monomers may be included in the polyol polymer component, in an amount up to about 90% by weight, preferably 50 to 80%. Such polymerizable monomers include, for example, styrene, methylstyrene, acrylamide, acrylonitrile, methacrylonitrile, methacrylamide, methylol methacrylamide, methylol acrylamide, and the like, and mixtures thereof.

One example of an acrylic polyol polymer comprises about 10-20% by weight of styrene, 40-60% by weight of alkyl methacrylate or acrylate having 1-6 carbon atoms in the alkyl group, and 10-50% by weight of hydroxy alkyl acrylate or methacrylate having 1-4 carbon atoms in the alkyl group. One such polymer contains about 15% by weight styrene, about 29% by weight iso-butyl methacrylate, about 20% by weight 2-ethylhexyl acrylate, and about 36% by weight hydroxy propylacrylate.

In addition to the above components, a dispersed polymer may optionally be included in the coating composition. Polymers dispersed in an organic (substantially non-aqueous) medium have been variously referred to, in the art, as a non-aqueous dispersion (NAD) polymer, a non-aqueous microparticle dispersion, a non-aqueous latex, or a polymer colloid. See generally, Barrett, DISPERSION POLYMERIZATION IN ORGANIC MEDIA (John Wiley 1975). See also U.S. Pat. Nos. 4,147,688; 4, 180,489; 4,075,141; 4,415, 681; 4,591,533; and 5,747,590, hereby incorporated by reference. In general, the non-aqueous dispersed polymer is characterized as a polymer particle dispersed in an organic media, which particle is stabilized by what is known as steric stabilization. According to the prior art, steric stabilization is accomplished by the attachment of a solvated polymeric or oligomeric layer at the particle-medium interface

The dispersed polymers are known to solve the problem of cracking typically associated with top coatings, particularly coatings containing silane compounds, and are used in an amount varying from about 0 to 30% by weight, preferably about 10 to 20%, of total weight of resin solids in the composition. The ratio of the silane compound to the dispersed polymer component of the composition suitably ranges from 5:1 to 1:10, preferably 4:1 to 1:5. To accommodate these relatively high concentrations of dispersed polymers, it is desirable to have reactive groups (e.g., hydroxy groups) on the solvated portion of the dispersed polymer, which reactive groups make the polymers compatible with the continuous phase of the system.

A preferred composition for a dispersed polymer that has hydroxy functionality comprises a core consisting of about 25% by weight of hydroxyethyl acrylate, about 4% by weight of methacrylic acid, about 46.5% by weight of methyl methacrylate, about 18% by weight of methyl acrylate, about 1.5% by weight of glycidyl methacrylate to provide a crosslinked core and about 5% of styrene. The solvated arms that are attached to the core contain 97.3% by weight of a pre-polymer and about 2.7% by weight of glycidyl methacrylate, the latter for crosslinking or anchoring of the arms. A preferred pre-polymer contains about 28% by weight of butyl methacrylate, about 15% by weight of ethyl methacrylate, about 30% by weight of butyl acrylate, about 10% by weight of hydroxyethyl acrylate, about 2% by weight of acrylic acid, and about 15% by weight of styrene.

The dispersed polymer can be produced by well known dispersion polymerization of monomers in an organic solvent in the presence of a steric stabilizer for the particles. The procedure has been described as one of polymerizing the monomers in an inert solvent in which the monomers are soluble but the resulting polymer is not soluble, in the presence of a dissolved amphoteric stabilizing agent.

A curing catalyst is typically added to catalyze the curing (i.e., crosslinking) reactions between the reactive components present in the composition. A wide variety of catalysts can be used, such as dibutyl tin dilaurate, dibutyl tin dilaurate, dibutyl tin diacetate, dibutyl tin dioxide, dibutyl tin dioctoate, tin octoate, aluminum titanate, aluminum chelates, zirconium chelate and the like. Sulfonic acids, such as dodecylbenzene sulfonic acid, either blocked or unblocked, are effective catalysts. Alkyl acid phosphates, such as phenyl acid phosphate, either blocked or unblocked, may also be employed. Any mixture of the aforementioned catalysts may be useful, as well. Other useful catalysts will readily occur to one skilled in the art. Preferably, the catalysts are used in the amount of about 0.1 to 5.0%, based on the total weight of the binder.

To improve the weatherability especially of a clear finish produced by the present coating composition, an ultraviolet light stabilizer or a combination of ultraviolet light stabilizers can be added to the topcoat composition in the amount of about 0. 1-10% by weight, based on the total weight of the binder. Such stabilizers include ultraviolet light absorbers, screeners, quenchers, and specific hindered amine light stabilizers. Also, an antioxidant can be added, in the about 0.1-5% by weight, based on the total weight of the binder. Typical ultraviolet light stabilizers that are useful include benzophenones, triazoles, triazines, benzoates, hindered amines and mixtures thereof.

A suitable amount of water scavenger such as trimethyl orthoacetate, triethyl orthoformate, tetrasilicate and the like (preferably 2 to 6% by weight of binder) is typically added to the topcoat composition for extending its pot life. Aged paint may also lose its silane activity for primerless windshield sealant adhesion compatibility, due to moisture-initiated silane hydrolysis and condensation. It is believed that the presence of a moisture scavenger such as trimethyl orthoacetate could inhibit such a process by reacting with water and forming methanol and butyl acetate. Such reaction products do not hurt the silane activity. In fact, in-situ generated alcohol such as methanol may even help the silane groups to work against the alcohol-exchange reaction with acrylic polyols typically present in the coating composition. The alcohol-exchange reaction, if allowed to proceed, tends to negatively impact the crosslink density of the coating film.

About 3% microgel (preferably acrylic) and 1% hydrophobic silica may be employed for rheology control. The composition may also include other conventional formulation additives such as flow control agents, for example, such as Resiflow® S (polybutylacrylate), BYK® 320 and 325 (high molecular weight polyacrylates).

When the present composition is used as a clearcoat (topcoat) over a pigmented colorcoat (basecoat), small amounts of pigment can be added to the clearcoat to eliminate undesirable color in the finish such as yellowing.

The present composition also can be highly pigmented and used as a monocoat or basecoat of a basecoat/clearcoat finish. When the present coating composition is used as a monocoat or basecoat, typical pigments that can be added to the composition include the following: metallic oxides such as titanium dioxide, zinc oxide, iron oxides of various colors, carbon black, filler pigments such as talc, china clay, barytes, carbonates, silicates and a wide variety of organic colored pigments such as quinacridones, copper phthalocyanines, perylenes, azo pigments, indanthrone blues, carbazoles such as carbozole violet, isoindolinones, isoindolones, thioindigo reds, benzimidazolinones, metallic flake pigments such as aluminum flake and other effect pigments such as pearlescent, i.e., mica, flakes, and the like.

The pigments can be introduced into the coating composition by first forming a mill base or pigment dispersion with any of the aforementioned polymers used in the coating composition or with another compatible polymer or dispersant by conventional techniques, such as high speed mixing, sand grinding, ball milling, attritor grinding or two roll milling. The mill base is then blended with the other constituents used in the coating composition.

Conventional solvents and diluents are used as the liquid carrier to disperse and/or dilute the above mentioned polymers to obtain the present coating composition. Typical solvents and diluents include toluene, xylene, butyl acetate, acetone, methyl isobutyl ketone, methyl ethyl ketone, methanol, isopropanol, butanol, hexane, acetone, ethylene glycol, monoethyl ether, VM and P naptha, mineral spirits, heptane and other aliphatic, cycloaliphatic, aromatic hydrocarbons, esters, ethers and ketones and the like.

The coating composition can be applied by conventional means including spraying, electrostatic spraying, dipping, brushing, flowcoating and the like. The preferred techniques are spraying and electrostatic spraying. After application, the composition is typically baked at 100-150° C. for about 15-30 minutes to form a coating about 0.1-3.0 mils thick.

The coating composition of this invention is typically formulated as a one-package system although two-package systems are possible as will occur to one skilled in the art. The one-package system has been found to have extended shelf life.

When the composition is used as a clearcoat in a basecoat/clearcoat finish, it is applied over the pigmented basecoat which can be dried to a tack-free state and cured or preferably flash-dried for a short period before the clearcoat is applied. It is customary to apply a clear topcoat over a solvent-borne basecoat by means of a “wet-on-wet” application, i.e., the topcoat is applied to the basecoat without completely drying the basecoat. The coated substrate is then heated for a predetermined time period to allow simultaneous curing of the base and clearcoats. Application over water-borne basecoat normally requires some period of drying of the basecoat before application of the clearcoat. After application of the clearcoat, the substrate is typically flashed again and finally baked until the film is cured, or at least partially cured, at 100-150° C. for about 15-30 minutes to produce the coated article. The basecoat and clearcoat are preferably deposited to have thickness of about 0.1-2.5 mils and 1.0-3.0 mils, respectively.

After application and at least partial cure, the clearcoat composition of the present invention is particularly useful in providing not only good adhesion to windshield sealants, but also excellent intercoat adhesion in a repair coating situation, where it is necessary to apply additional coatings, such as a repair basecoat followed by a repair clearcoat, to the substrate having cured thereon a cured basecoat and a cured clearcoat layer. In a preferred embodiment, the repair and original basecoat compositions are the same and the original and repair topcoat or clearcoat compositions are the same. The repair coating is typically cured at temperatures between at 100-150° C. for about 15-30 minutes to produce the coated article having a repair basecoat/clearcoat finish over the original basecoat/clearcoat finish. Actual examples of repair methods as well as windshield adhesion test methods are set forth in the examples.

### EXAMPLES

The invention is further described in the following non-limiting examples. All parts and percentages in the examples are on a weight basis unless otherwise indicated. All molecular weights disclosed herein are determined by GPC using a polystyrene standard.

The following resins were prepared and used as indicated in Clearcoat Examples 1-2 and Comparative Examples 3 and 4.

### Resin Example 1

### Preparation of Carbamate Functional Oligomer For Use in Clearcoat Examples

A carbamate functional oligomer was prepared by charging the following ingredients into a reaction flask equipped with a heating mantle, stirrer, thermometer, nitrogen inlet and a reflux condenser:

| | Parts by Weight (g) |
|---|---|
| Portion I | |
| Ethyl 3-ethoxy propionate | 796 |
| Isocyanurate of hexane diisocyanate (Desmodur ® | 1738 |
| 3300 from Bayer Corporation) | |
| Dibutyl tin dilaurate | 0.1 |
| Portion II | |
| Ethyl 3-ethoxy propionate | 41 |
| Iso-butanol | 577 |
| Portion III | |
| Pripol 2033 dimer diol (from Unichema | 319 |
| International, hydroxy value of 196-206) | |
| Portion IV | |
| Butanol | 41 |
| Total | 3512 |

Portion I was pre-mixed and charged into the reaction flask and heated to 100° C. under agitation and a nitrogen blanket. Then Portion II was added over a 90 minute period, in order to keep the exotherm temperature at or below 120° C. Immediately following that, Portion III was added over a period of 15 minutes at 120° C. The reaction mixture was then held at 120° C. while mixing until essentially all of the isocyanate was reacted as indicated by infrared scan. After NCO in the IR absorbance plot is no longer detected, the reaction mixture was cooled to below 100° C. and Portion IV was then added to adjust the solids content of the resulting solution to 75%.

The resulting solution contained the following constituents HDI Trimer/Isobutanol/Pripol Diol in a weight ratio of 66/22/12, had a Mw of about 3,900, and a polydispersity of 1.82.

### Resin Example 2

### Preparation of Hydroxy Functional Acrylosilane Polymers 1-2 and Hydroxy-Free Monofunctional Acrylosilane Polymer 3 for Use in Clearcoat Examples

Acrylosilane polymer solutions were prepared by copolymerizing in the presence of a 2/1 Solvesso 100 Aromatic Solvent/butanol mixture, monomer mixtures of styrene (S), hydroxypropyl acrylate (HPA), methacryloxypropyl trimethoxy silane (MAPTS) (Silquest® A-1 74 from Crompton), butyl acrylate (BA), and isobutyl methacrylate (IBMA) in the presence of 8 parts by weight of Vazo® 67. The resulting polymer solution has a 71% solids content and a viscosity of F-R on the Gardner Holdt scale measured at 25 ° C. The polymer compositions are described in Table 1 and they all have a weight average molecular weight of approximately 4,500 gram/mole.

TABLE 1

| | Silane | Silane | Silane |
|---|---|---|---|
| | Polymer 1 | Polymer 2 | Polymer 3 |
| HPA | 10 | 5 | 0 |
| MAPTS | 65 | 65 | 65 |
| Sty | 10 | 10 | 15 |
| IBMA | 12 | 17 | 17 |
| BA | 3 | 3 | 3 |

### Resin Example 3

### Preparation of an Acrylic Polyol Resin for Use in Clearcoat Examples

An acrylic polyol resin was prepared by charging the following to a 5-liter round bottom flask equipped as above:

| | Parts by Weight (g) |
|---|---|
| Portion I | |
| Aromatic 100 | 736 |
| Portion II | |
| Styrene | 361 |
| Butyl methacrylate | 722 |
| Butyl acrylate | 403 |
| Hydroxypropyl Acrylate | 921 |
| Aromatic 100 | 111 |
| Portion III | |
| t-Butyl Peroxyacetate | 22 |
| Aromatic 100 | 131 |
| Total | 3407 |

Portion I was charged into the reactor and heated to reflux temperature (160-168° C.). Portion II was premixed and then added dropwise to the reaction flask while the reaction mixture was held at reflux temperature, over a 180 minute period. The reaction mixture was then held under agitation at 144° C. for 2 hours. Portion III was premixed and added simultaneously with Portion II dropwise to the reactor over a period of 195 minutes. The solution was then held at reflux temperature for 1 hour.

The resulting acrylic polyol resin was 71.1% by weight solids, and had a weight average molecular weight of about 7000.

### Resin Example 4

### Preparation of an Acrylic Microgel for Use in Clearcoat Examples

A methyl methacrylate/glycidyl methacrylate copolymer was prepared as an intermediate stabilizing polymer used in the synthesis of the below acrylic microgel resin. This stabilizing polymer was prepared by charging the following to a nitrogen blanketed flask equipped as above:

| | Parts by Weight (g) |
|---|---|
| Portion I | |
| n-Butyl acetate | 195.800 |
| Portion II | |
| Methyl methacrylate | 139.000 |
| n-Butyl acetate | 14.410 |
| Glycidyl methacrylate | 13.060 |
| Glycidyl methacrylate/12-Hydroxystearic | 181.660 |
| acid copolymer | |
| (60% by weight solids solution of 89.2% 12-HAS/ | |
| 10.8% GMA in a 80/20 blend of toluene and | |
| petroleum naphtha) | |
| Petroleum Naphtha (Exxsol ® D-3135 from Exxon) | 40.570 |
| n-Butyl acetate | 13.060 |
| Portion III | |
| 2,2′-azobis(2-methylbutyronitrile) | 8.010 |
| n-Butyl acetate | 71.590 |
| Petroleum Naphtha (Exxsol ® D-3135 from Exxon) | 74.330 |
| Portion IV | |
| 4-tert-Butyl catechol | 0.040 |
| n-Butyl acetate | 2.690 |
| Portion V | |
| Methacrylic acid | 2.710 |
| n-Butyl acetate | 6.020 |
| Portion VI | |
| N,N′-dimethyl dodecyl amine | 0.360 |
| n-Butyl acetate | 2.690 |
| Total | 766 |

Portion I was charged to the reactor and brought to a temperature of 96 to 100° C. Portions II and III were separately premixed and then added concurrently over a 180 minute period, while maintaining a reaction temperature of 96 to 100° C. The solution was then held for 90 minutes. In sequence, Portions IV, V, and VI were separately premixed and added to the reactor. The reaction solution was then heated to reflux and held until the acid number is 0.5 or less. The resulting polymer solution has a 40% solids content.

The acrylic microgel resin was then prepared by charging the following to a nitrogen blanketed flask equipped as above:

| | Parts by Weight (g) |
|---|---|
| Portion I | |
| Methyl methacrylate | 15.187 |
| Mineral spirits (Exxsol ® D40 from Exxon) | 97.614 |
| Methyl methacrylate/Glycidyl methacrylate | 4.678 |
| stabilizer copolymer (prepared above) | |
| Heptane | 73.638 |
| 2,2′-azobis(2-methylbutyronitrile) (Vazo 67 from | 1.395 |
| DuPont) | |
| Portion II | |
| N,N-dimethylethanolamine | 1.108 |
| Methyl methacrylate | 178.952 |
| Methyl methacrylate/Glycidyl methacrylate | 58.271 |
| stabilizer copolymer (prepared above) | |
| Glycidyl methacrylate | 2.816 |
| Methacrylic acid | 2.816 |
| Styrene | 75.302 |
| Hydroxy Ethyl Acrylate | 23.455 |
| Heptane | 198.512 |
| Mineral Spirits (Exxsol ® D40 from Exxon) | 32.387 |
| Portion III | |
| 2,2′-azobis(2-methylbutyronitrile) (Vazo 67 from | 2.024 |
| DuPont) | |
| Toluene | 12.938 |
| Heptane | 30.319 |
| Portion IV | |
| Heptane | 9.588 |
| Portion V | |
| Resimene ® 755 | 246.3 |
| Total | 1067.3 |

Portion I was charged into the reaction vessel, heated to its reflux temperature, and held for 60 minutes. Portions II and III were premixed separately and then added simultaneously over a 180 minute period to the reaction vessel mixed while maintaining the reaction mixture at its reflux temperature. Portion IV was then added. The reaction solution was then held at reflux for 120 minutes and then 246.3 pounds of the solvent was stripped. The resin was then cooled to 60° C. and mixed with Portion V. Mixing was continued for 30 minutes.

The resulting polymer solution has a weight solids of 70%, and a viscosity of 50 centipoise (By Brookfield Model RVT, Spindle #2, at 25° C.).

### Examples 1-2 and Comparative Examples 3 and 4

### Preparation of Clearcoat Compositions

Four clearcoat compositions were prepared by blending together the following ingredients in the order given:

TABLE 2

| | Ex. 1 | Ex. 2 | C. Ex. 3 | C. Ex. 4 |
|---|---|---|---|---|
| Microgel¹ | 3% | 3% | 3% | 3% |
| Melamine² | 21% | 21% | 21% | 21% |
| HALS Tinuvin | 1% | 1% | 1% | 1% |
| 123³ | | | | |
| UVA Tinuvin | 2% | 2% | 2% | 2% |
| 928³ | | | | |
| NAD⁴ | 20% | 20% | 20% | 20% |
| Catalyst⁵ | 1.2% | 1.2% | 1.2% | 1.2% |
| Carbamate⁶ | 30% | 30% | 30% | 30% |
| Acrylic Polyol⁷ | 7% | 12% | 12% | 17% |
| Flow Aid⁸ | 0.31% | 0.31% | 0.31% | 0.31% |
| Silica Dispersion⁹ | 10% | 10% | 10% | 10% |
| | f.w. | f.w. | f.w. | f.w. |
| Moisture | 2% | 2% | 2% | 2% |
| Scalvenger¹⁰ | f.w. | f.w. | f.w. | f.w. |
| Silane Polymer 1 | 9.2% | | | |
| Silane Polymer 2 | | 5% | | |
| Silane Polymer 3 | | | 5% | |
| Solvent¹¹ | 13% | 13% | 13% | 13% |
| | f.w. | f.w. | f.w. | f.w. |

Table Footnotes
*All the numbers in this table are by % non-volatile, except for those noted as f.w. which means by formula weight.
¹Resin Example 4.
²Cymel ® 1161 monomeric melamine supplied by Cytec Industries Inc., West Patterson, New Jersey.
³Tinuvin ® 123 supplied by Ciba Specialty Chemicals, Tarrytown, New York.
³Tinuvin ® 928 supplied by Ciba Specialty Chemicals, Tarrytown, New York.
⁴Non-aqueous dispersion resin (NAD) prepared in accordance with the procedure described in the U.S. Pat. No. 5,747,590 at column 8, lines 46-68 and column 9, lines 1-25, all of which is incorporated herein by reference.
⁵Dodecyl benzene sulfonic acid salt of 2-amino-2-methyl-1-propanol supplied by King Industries, Norwalk, Connecticut.
⁶Resin Example 1.
⁷Resin Example 3.
⁸Resiflow supplied by Estron Chemicals, Inc., Parsippany, New Jersey.
⁹Fumed silica grind.
¹⁰Trimethyl orthoacetate supplied by Chem Central.
¹¹50/50 blend of N-butyl butanol and Aromatic 100 supplied by Exxon Mobil Chemical.

### Paint Results

The coating compositions of Examples 1-2 and Comparative Examples 3 and 4 were reduced to 40 seconds on a #4 Ford cup with ethyl 3-ethoxy propionate (EEP) and hand-sprayed to a black basecoat over a steel substrate which was already coated with a layer each of electrocoat and primer surfacer. The basecoat used is commercially available from DuPont under DuPont Code of M-6373 (Ebony). The primer surfacer used is commercially available from DuPont under DuPont Code of 708S43301 (Taupe). The electrocoat used is commercially available from DuPont under the name of ED5050.

The basecoat was applied by hand-spray in one coat to a primed, electrocoated steel substrate. After an approximately 3 minutes of flash time under a booth condition of 75° F. and 55% humidity, the coating compositions of Examples 1-2 and Comparative Examples 3 and 4were applied to the base-coated panels in two coats with 60 seconds flash in between. The applied clearcoats were allowed to flash in air for approximately 10 minutes before baking.

For the testing of adhesion to windshield adhesives, the clearcoated panels of Examples 1-2 and Comparative Examples 3 and 4 were baked at 135° C. for 10 minutes. The final dry film thicknesses were 10-15 microns for the Ebony basecoat and 45-50 microns for the clearcoat. A bead of windshield adhesive was applied to the clearcoat surface primeness within 12 hours of bake for quick knife adhesion test according to GM4352M and GM9522P specifications published by General Motors Corporation. The windshield adhesive used is commercially available from Dow Essex Specialty Products company and is identified as Betaseal™ 15625.

The windshield adhesive bead was allowed to cure for 72 hours at 73° F. (23° C.) and 50% humidity. The size adhesive beads were about 6×6×250 mm and the cured beads were cut with a razor blade with a minimum of 10 cuts. The interval between the cuts was at least 12 mm apart. The desirable result is 100% cohesive failure (CF) of the adhesive beads, rather than a failure due to a loss of adhesion between the adhesive and the clearcoat or within the clearcoat or underlayers. The result of 0% CF means there were no adhesion at all between the adhesive beads and the clearcoat when the bead was pulled away from the clearcoat. The results for Examples 1-2 and Comparative Examples 3 and 4 are reported in Table 3, below.

For recoat adhesion, the applied basecoats and clearcoats were baked at 155° C. for 60 minutes. Within 24 hours of the bake, the same basecoats and clearcoats were applied the same procedure described above over the top of the baked OEM basecoat and clearcoat. The newly applied topcoats were baked again at 135° C. for 10 minutes. These recoated panels were then aged for a minimum of 24 hours and tested for recoat adhesion according to Method “B” of FLTM BI 106-01 published by Ford Motor Company.

The results of adhesion to windshield adhesive beads and the recoats are summarized in Table 3:

TABLE 3

| | | | | | Overbake/Under |
|---|---|---|---|---|---|
| | | | Silane | MVSS | bake Recoat |
| | | | A-174 | Primerless | Adhesion |
| Clearcoat | Clearcoat System | Silane Polymer | Level* | Compatibility | Removal** |
| Ex. 1 | Acrylic/Carbamate/Melamine | Silane Polymer 2 | 6% | 100% CF | <2% |
| Ex. 2 | Acrylic/Carbamate/Melamine | Silane Polymer 3 | 3.3% | 100% CF | <2% |
| C. Ex. 3 | Acrylic/Carbamate/Melamine | Silane Polymer 4 | 3.3% | 100% CF | >80% |
| C. Ex. 4 | Acrylic/Carbamate/Melamine | None | 0% | 0% CF | <2% |

Table Footnotes
*Percent weight of Silquest ® A-174 by the total dry solids.
**Test protocols established in Method “B” of FLTM BI 106-01 require <5% removal for the paint to be acceptable by Ford Motor Company.

As Table 3 shows, strong adhesion of the clearcoat (CC) to the windshield adhesive beads can be achieved through use of both dual and mono-functional silane polymers (see CC examples 1-2, in comparison with CC example 3). However, the level of the silane polymers needed for the primeness adhesion to the windshield beads was dependent on the level of HPA (hydroxyl content) in the silane polymer. For example, for silane polymer 1 which contains 10% HPA, it needed 6% of A-174 (weight by total solids) to obtain primeness adhesion to the windshield beads. While, when the HPA level were lowered to 5% or none, only 3.3% or less of A-174 level (weight by total solids) were needed to establish a strong link-up between the clearcoats and the adhesive beads (see clearcoat examples 2-4).

These results suggest that the OH functional groups in the silane polymers play a critical role in deciding how much active silane groups would be available on the surface to link up with the windshield beads without prime. On the other hand, the OH functional groups also play a critical role in achieving the recoat adhesion of the clearcoats. As seen from the data of clearcoat example 3, which uses the monofunctional silane polymer 3, a silane resin which does not contain any OH functional groups, it lost 80% as much of its recoat adhesion after test. By contrast, all the clearcoat using OH-containing dual functional silane had less than 2% of paint removal by the test. Thus, use of monofunctional silane in the clearcoat caused a significant loss of recoat adhesion.

Various other modifications, alterations, additions or substitutions of the component of the compositions of this invention will be apparent to those skilled in the art without departing from the spirit and scope of this invention. This invention is not limited by the illustrative embodiments set forth herein, but rather is defined by the following claims.

1. A curable coating composition comprising a film-forming binder and an organic liquid carrier; wherein the binder comprises:
(A) at least one curable compound having a plurality of carbamate groups;
(B) at least one alkylated melamine formaldehyde or other aminoplast crosslinking agent;
(C) at least one film-forming reactive hydroxy functional silane compound having an average of at least one hydrolyzable silyl group and a hydroxyl value of about 4 to 40.

2. The composition of claim 1, wherein component (a) is a secondary carbamate oligomer.

3. The composition of claim 1, wherein component (c) is a hydroxy-functional acrylosilane polymer.

4. The composition of claim 1, wherein component (b) is an alkylated melamine formaldehyde resin.

5. The composition of claim 1, wherein the composition includes up to 60% by weight, based on the weight of the binder, of component (a).

6. The composition of claim 1, wherein the composition includes greater than 2% by weight, based on the weight of the binder, of component (c).

7. A curable coating composition comprising about 45-90% by weight of a film-forming binder and about 10-55% by weight of an organic liquid carrier; wherein the binder contains:
(A) a curable film-forming oligomer or polymer having a plurality of secondary carbamate groups;
(B) an alkylated melamine formaldehyde or other aminoplast crosslinking agent;
(C) a curable film-forming hydroxy functional silane oligomer or polymer having a hydroxyl number of about 4 to 40 and comprising polymerized ethylenically unsaturated monomers of which about 10 to 97% by weight contain hydrolyzable silyl functionality; and
(D) optional non-aqueous dispersed polymer,
wherein the content of component (c) in the binder ranges from about 2 to about 55% by weight, based on the total weight of the binder.

8. The composition of claim 7 wherein component (c) is an acrylic polymer consisting essentially of polymerized monomers of styrene, an ethylenically unsaturated alkoxy silane monomer selected from the group consisting of acrylate, methacrylate or vinyl monomer or any mixtures thereof, a nonfunctional acrylate or methacrylate and a hydroxy alkyl acrylate or methacrylate that has 1-4 carbon atoms in the alkyl group; wherein the acrylic polymer has a weight average molecular weight of about 1,000-20,000.

9. The composition of claim 8 wherein the acrylic polymer consists essentially of polymerized monomers of styrene, gamma-methacryloxypropyl trimethoxysilane, isobutyl methacrylate, butyl acrylate, and hydroxy propyl acrylate.

10. The composition of claim 9 wherein the acrylic polymer consists essentially of polymerized monomers of about 1-30% by weight styrene, 1-96% by weight gamma-methacryloxypropyl trimethoxysilane, and 1-30% by weight isobutyl methacrylate, 1-30% by weight of butyl acrylate and about 1-9% by weight hydroxy propyl acrylate where the total percentage of monomers in the polymer equals 100%.

11. The composition of claim 7 wherein the composition further contains a moisture scavenger selected from the group consisting of trimethyl orthoacetate, triethyl orthoformate, tetrasilicate, and the like and any mixtures thereof.

12. A coating composition having a film-forming binder comprising a carbamate functional material, a melamine curing agent, and a silane functional resin with a hydrolyzable silane group, wherein the improvement is the use of a sufficient amount of hydroxy functional silane material having a hydroxyl value of about 4 to 40, to achieve recoat adhesion without destroying its primeness adhesion to windshield sealants.

13. The coating composition of claim 1, wherein said composition is a clearcoat for a basecoat/clearcoat finish.

14. The coating composition of claim 7, wherein said composition is a clearcoat for a basecoat/clearcoat finish.

15. The coating composition of claim 12, wherein said composition is a clearcoat for a basecoat/clearcoat finish.

16. A substrate coated with the dried and cured composition of claim 1.

17. An automobile or truck exterior body coated with the dried and cured composition of claim 1.

18. A process for coating a substrate, comprising:
(A) applying a layer of a pigmented basecoating to the substrate to for a basecoat thereon;
(B) applying over said basecoat, a clearcoat layer comprised of the composition of claim 1;
(C) curing the basecoat and clearcoat to for a topcoat over the substrate.
